(19) United States
(12) Patent Application Publication
(10) Pub. No.: US 2016/0119849 A1
(43) Pub. Date: Apr. 28, 2016

(54) REDUCING LATENCY OF REDIRECTION DURING A CONCURRENTLY TRIGGERED RESELECTION

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/523,703

(22) Filed: Oct. 24, 2014

(51) Int. Cl. H04W 36/30; H04W 36/32; H04W 36/16; H04W 36/04

(52) U.S. Cl. CPC H04W 36/30; H04W 36/04; H04W 36/32; H04W 36/165

(57) ABSTRACT

A user equipment (UE) measures a signal quality of a serving cell and/or a signal quality of one or more cell reselection target cells. The UE reduces latency of circuit switched fallback (CSFB) procedure when a cell reselection from a first RAT to a second RAT is concurrently triggered. In one instance, the UE reduces latency by determining whether to abort a cell reselection procedure based on a signal quality of a serving cell and/or a signal quality of at least one cell reselection target cell, when a circuit switched fall back call has been triggered.

### BACKGROUND

1. Field

Aspects of the present disclosure relate generally to wireless communication systems, and more particularly, to reducing latency of redirection from one radio access technology (RAT) to another RAT when cell reselection is concurrently triggered.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes determining whether to abort a cell reselection procedure based at least in part on a signal quality of a serving cell and/or a signal quality of at least one cell reselection target cell, when a circuit switched fall back (CSFB) call has been triggered.

According to another aspect of the present disclosure, an apparatus for wireless communication includes means for identifying a signal quality of a serving cell and/or a signal quality of at least one cell reselection target cell. The apparatus may also include means for determining whether to abort a cell reselection procedure based at least in part on a signal quality of a serving cell and/or a signal quality of at least one cell reselection target cell, when a circuit switched fall back (CSFB) call has been triggered.

Another aspect discloses an apparatus for wireless communication and includes a memory and at least one processor coupled to the memory. The processor(s) is configured to determine whether to abort a cell reselection procedure based at least in part on a signal quality of a serving cell and/or a signal quality of at least one cell reselection target cell, when a circuit switched fall back (CSFB) call has been triggered.

Yet another aspect discloses a computer program product for wireless communications in a wireless network having a non-transitory computer-readable medium. The computer readable medium has non-transitory program code recorded thereon which, when executed by the processor(s), causes the processor(s) to determine whether to abort a cell reselection procedure based at least in part on a signal quality of a serving cell and/or a signal quality of at least one cell reselection target cell, when a circuit switched fall back (CSFB) call has been triggered.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a user equipment (UE) in a telecommunications system.

FIG. 4 illustrates network coverage areas according to aspects of the present disclosure.

FIG. 5 is a call flow diagram illustrating latency reduction when a circuit switched fall back procedure and a cell reselection procedure are concurrently triggered according to aspects of the present disclosure.

FIG. 6 is a block diagram illustrating a method for wireless communication according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

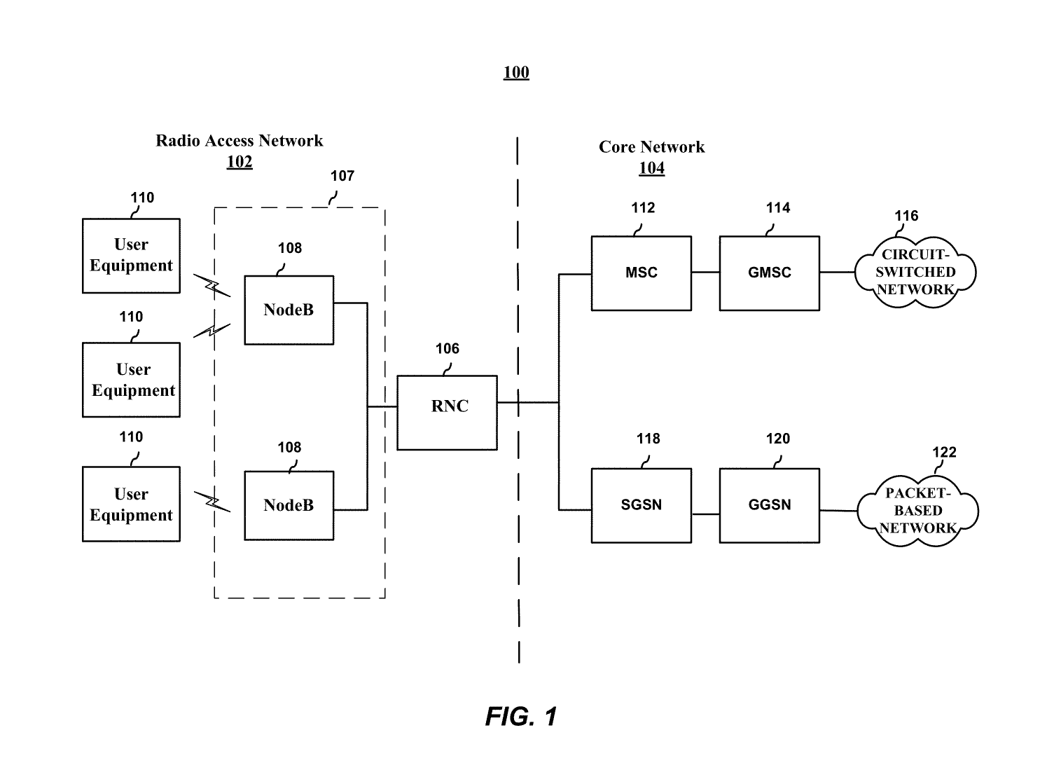

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

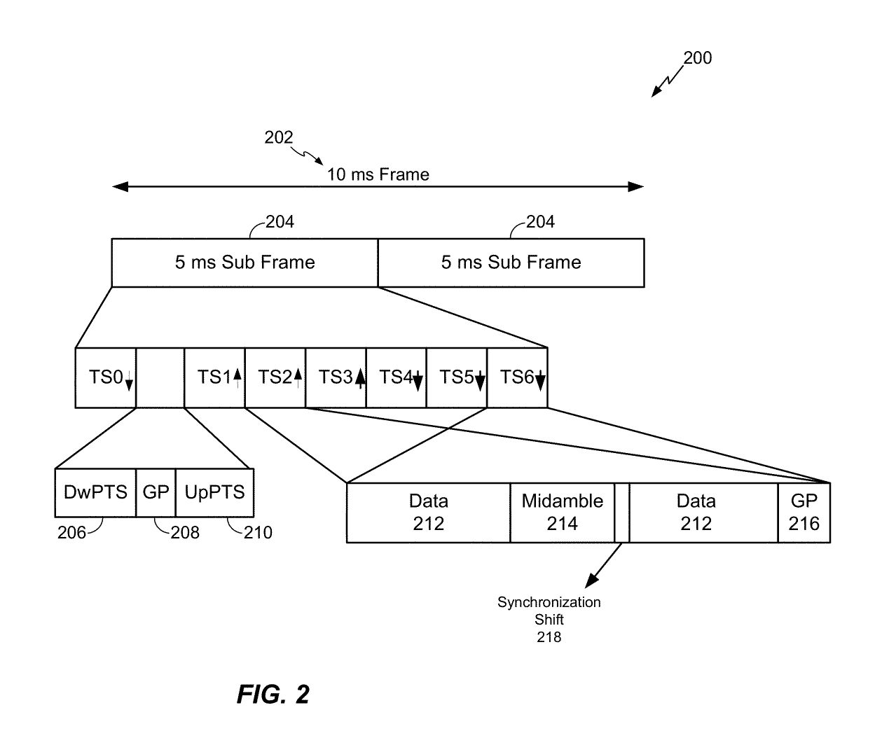

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

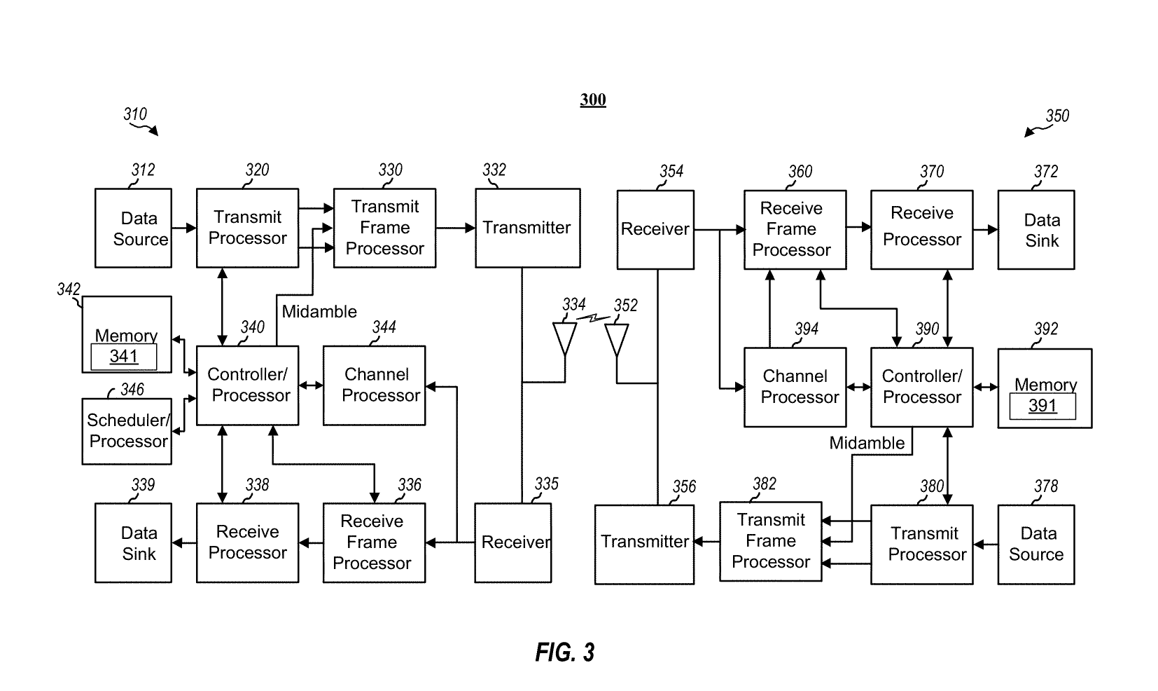

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a redirection/reselection module 391 which, when executed by the controller/processor 390, configures the UE 350 for the latency reduction implementation according to aspects of the present disclosure. A scheduler/processor 346 at the node B 310 may be used to allocate resources to the UEs and schedule downlink and/or uplink transmissions for the UEs. For example, the memory 342 of the node B 310 may store a redirection module 341 which, when executed by the controller/processor 340, configures the node B 340 for circuit switched fall back redirection across mobile switching center pools.

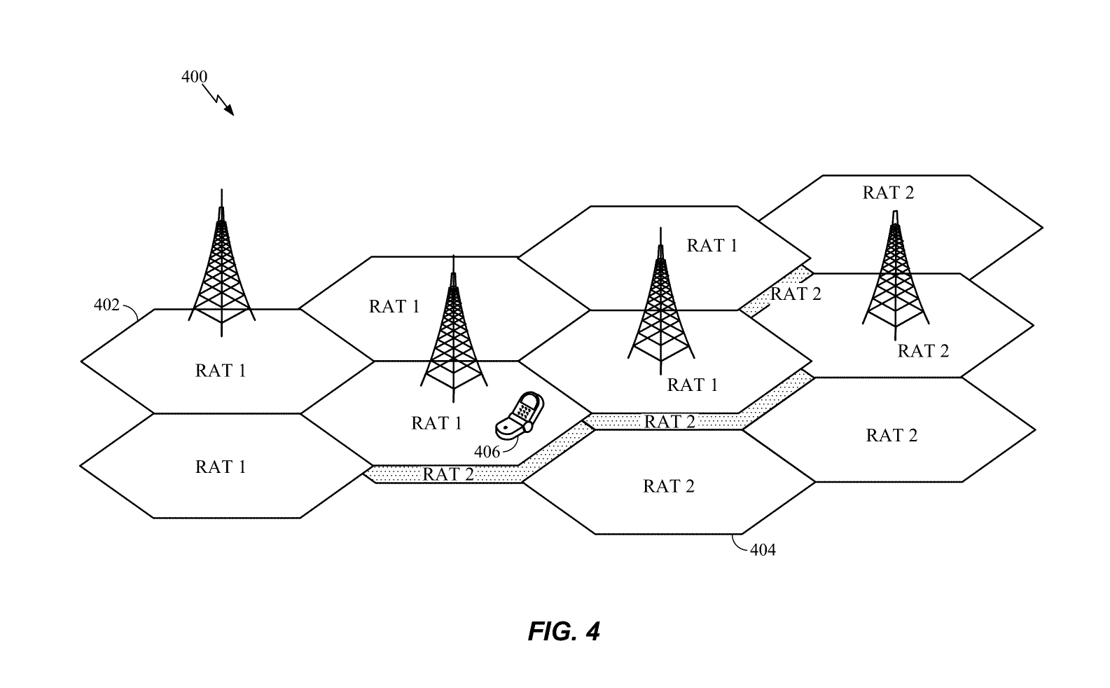

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as GSM, TD-SCDMA or Long Term Evolution (LTE) and also illustrates a newly deployed network utilizing a second type of radio access technology (RAT-2), such as a GSM, TD-SCDMA or Long Term Evolution (LTE).

The geographical area 400 may include RAT-1 cells 402 and RAT-2 cells 404. In one example, the RAT-1 cells are TD-SCDMA/GSM cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

The handover or cell reselection may be performed when the UE moves from a coverage area of a TD-SCDMA cell to the coverage area of an LTE cell, or vice versa. A handover or cell reselection may also be performed when there is a coverage hole or lack of coverage in the TD-SCDMA network or when there is traffic balancing between the TD-SCDMA and LTE networks. As part of that handover or cell reselection process, while in a connected mode with a first system (e.g., TD-SCDMA) a UE may be specified to perform activities related to a neighboring cell (such as LTE cell). For example, the UE may measure the neighbor cells of a second network for signal quality, frequency channel, and base station ID. The UE may then connect to the strongest cell of the second network. Such measurement may be referred to as inter radio access technology (IRAT) measurement.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc. Signal quality is intended to cover the term signal strength, as well.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. For example, the measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold.

In some instances, when the UE is in a connected mode or idle mode with the serving RAT, the UE may be redirected to a target RAT to initiate or receive a voice call, redirection from one RAT to another RAT is commonly used to perform operations such as load balancing or circuit switched fallback from one RAT to another RAT. For example, one of the RATs may be long term evolution (LTE) while the other RAT may be universal mobile telecommunications system-frequency division duplexing (UMTS FDD), universal mobile telecommunications system-time division duplexing (UMTS TDD), or global system for mobile communications (GSM). In some aspects, the redirection may be from a frequency or cell of one RAT to a frequency or cell of the same RAT.

Circuit switched fall back is a feature that enables multimode user equipments (UEs) that are capable of communicating on a first RAT (e.g., LTE) in addition to communicating on a second RAT (e.g., second/third generation (2G/3G) RAT) to obtain circuit switched voice services while being camped on the first RAT. For example, the circuit switched fall back capable UE may initiate a mobile-originated (MO) circuit switched voice call while on LTE. Because of the mobile-originated circuit switched voice call, the UE is redirected to a circuit switched capable RAT. For example, the UE is redirected to a radio access network (RAN), such as a 3G/2G network, for the circuit switched voice call setup. In some instances, the circuit switched fall back capable UE may be paged for a mobile-terminated (MT) voice call while on LTE, which results in the UE being moved to 3G or 2G for the circuit switched voice call setup.

When a reselection procedure is triggered concurrently with an initiation or reception of a circuit switched fall back (CSFB) call at a user equipment (UE), the UE may be subject to an increased latency of redirection from a first RAT to a second RAT (e.g., a circuit switched fall back RAT). The increase in latency may result from performing the cell reselection procedure before setting up the circuit switched fall back call. For example, if the UE is currently associated with a first LTE RAT, and cell reselection to a second LTE RAT is triggered concurrently with the initiation of a circuit switched call, the UE may reselect to the second LTE RAT before redirecting to a circuit switched fall back RAT. Thus, the redirection to the circuit switched fall back RAT is delayed until the UE is switched to the second LTE RAT. Because circuit switched fall back calls are time sensitive, the increased delay may degrade performance and negatively affect user perception. In another example, a mobile page associated with a first mobile switching center (MSC) pool area could be lost as the UE reselects to a base station associated with a different MSC pool. In this example, after cell reselection, the UE sends a page response to the other MSC pool. Because the other MSC pool is not aware of the page, (because the page may not be forwarded across MSC pools) the call setup would fail.

### Reducing Latency of Redirection During a Concurrently Triggered Reselection

Aspects of the disclosure are directed to reducing latency of a circuit switched fallback (CSFB) procedure when a cell reselection from a first RAT to a second RAT is concurrently triggered. In one aspect of the present disclosure, a user equipment (UE) determines whether to abort the cell reselection procedure based on a signal quality of a first RAT (e.g., serving cell/frequency of the first RAT) and/or a signal quality of one or more cell reselection target cells, when a circuit switched fall back (CSFB) call is triggered. For example, the UE may abort the cell reselection procedure in favor of a circuit switched fall back procedure on the serving cell or continue the cell reselection procedure and delay the circuit switched fall back procedure until the UE is redirected to a new serving cell.

In one aspect of the disclosure, when the serving cell signal quality exceeds an absolute threshold the UE aborts the cell reselection procedure in response to the CSFB call being triggered. The UE may abort the cell reselection procedure based on a cell reselection timer. The cell reselection timer governs when the UE may reselect to a new serving cell. Even if the UE has determined that a potential cell reselection target cell is higher ranked than the serving cell, the UE may not be permitted to reselect to the cell reselection target cell until expiration of the timer. For example, if the potential cell reselection target cell continues to rank higher than the serving cell upon expiration of the cell reselection timer, then the UE reselects to the cell reselection target cell.

In one aspect of the disclosure, the UE aborts the cell reselection procedure when the cell reselection timer expires or when the cell reselection timer is running and not expired. When the cell reselection procedure is aborted, the UE may perform the circuit switched fall back procedure at the serving cell so that the UE is redirected to a circuit switched RAT (e.g., GSM/TD-SCDMA) for the circuit switched fall back call. For example, the UE performs the circuit switched fall back (CSFB) procedure on the serving cell, rather than perform the cell reselection procedure to reselect the target cell.

In another aspect of the disclosure, when the serving cell signal quality is below the absolute threshold, the UE delays the circuit switched fall back procedure until the cell reselection procedure is completed. Thus, the UE performs the cell reselection procedure to reselect a new serving cell and delays the circuit switched fall back procedure until the cell reselection is completed. The UE then resumes the circuit switched fall back procedure on the new serving cell.

The UE may determine whether to abort the cell reselection procedure or delay the circuit switched fall back procedure based on a difference in signal quality between the serving cell and the cell reselection target cell. For example, the UE may abort the cell reselection when the difference in signal quality between the serving cell and the cell reselection target cell falls below a difference threshold. That is, when the signal quality of the target cell is higher than the signal quality of the serving cell but the difference in signal qualities is below the difference threshold, the UE aborts the cell reselection.

In another aspect of the disclosure, the UE determines whether to abort the cell reselection procedure or delay the circuit switched fall back procedure based on a percentage of the circuit switched fall back procedure completed. In one instance, the UE may delay the circuit switched fall back procedure until the cell reselection procedure is completed before the UE resumes the circuit switched fall back procedure on the new serving cell. For example, if a small percentage of the circuit switched fall back procedure is completed, the UE may proceed with the cell reselection procedure and delay the circuit switched fall back procedure. The UE may then resume the circuit switched fall back procedure at the new serving cell. However, when a large percentage of the circuit switched fall back procedure is completed, the UE may abort the cell reselection procedure in favor of the circuit switched fall back procedure. As a result, the UE is redirected to a circuit switched RAT for the circuit switched fall back call.

The UE may determine whether to abort the cell reselection or delay the circuit switched fall back procedure based on a percentage of the cell reselection procedure completed. For example, when a large percentage of the cell reselection procedure is completed, the UE may continue with the cell reselection procedure and delay the circuit switched fall back procedure. The UE may then resume the circuit switched fall back procedure at the new serving cell. However, the UE may abort the cell reselection procedure and perform the circuit switched fall back procedure at the serving cell when only a small percentage of the cell reselection procedure is completed. As a result, the UE is redirected to the circuit switched RAT for the circuit switched fall back call.

In one aspect of the disclosure, the user equipment stops measurements of neighbor cells when the circuit switched fall back call has been triggered and the signal quality of the serving cell is above an absolute threshold. For example, the user equipment stops intra frequency, inter frequency and/or inter radio access technology (RAT) measurements when the circuit switched fall back call has been triggered and the signal quality of the serving cell is above an absolute threshold.

In another aspects of the disclosure, the cell reselection may be an intra-frequency cell reselection or inter frequency cell reselection. For example, the cell reselection may be between a current LTE serving cell/frequency and a target LTE cell. In this case, the cell reselection may be triggered when the current LTE serving cell is weak and the target LTE cell is strong. Similarly, the cell reselection may be between a current LTE serving cell and a target time division-synchronous code division multiple access (TD-SCDMA) cell.

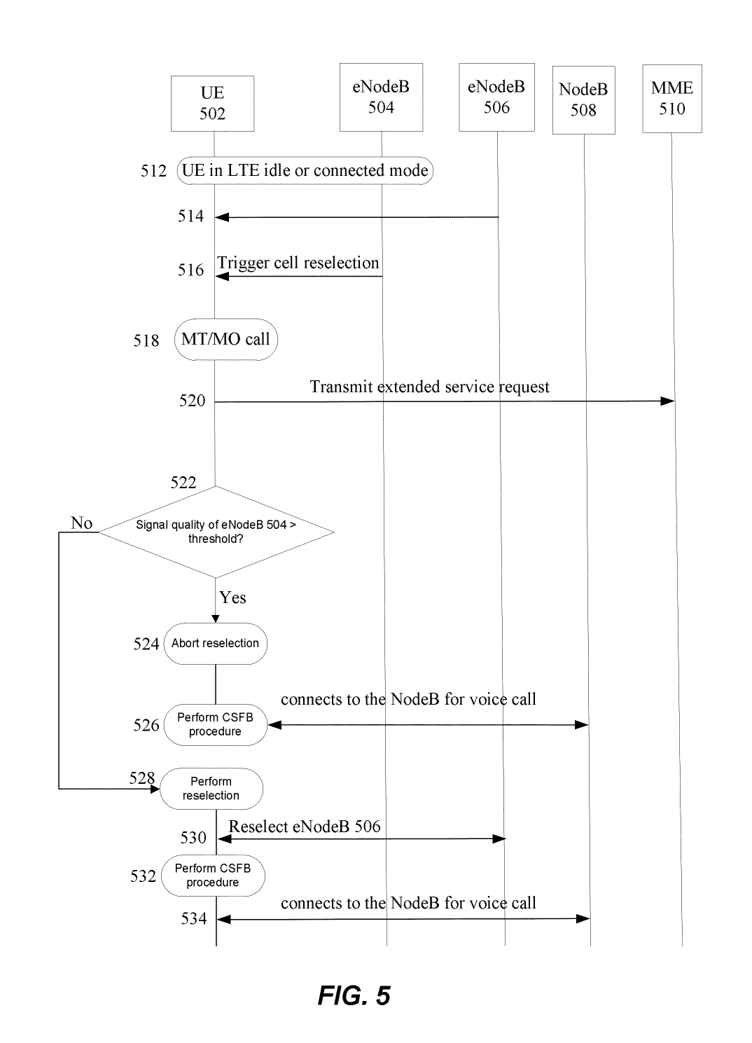

FIG. 5 is a call flow diagram illustrating latency reduction when a circuit switched fall back procedure and a cell reselection procedure are concurrently triggered according to aspects of the present disclosure. A UE 502 may be in a coverage area of a first base station (e.g., eNodeB 504) corresponding to a first cell of a first RAT (e.g., LTE), a second base station (e.g., eNodeB 506) corresponding to a second cell of the first RAT, a third base station (e.g., NodeB 508) corresponding to a second RAT (e.g., GSM/TD-SCDMA)) and a mobility management entity (MME) 510, which is a control node for the network. At time 512, the UE 502 is in the idle or connected mode (e.g., for a data call) with the eNodeB 504 (i.e., serving base station). While in the idle or connected mode with the eNodeB 504, the UE 502 may perform activities associated with the frequencies/cells of the neighboring RATs and the serving RAT. For example, the UE 502 may measure a signal quality of the first cell/frequency of the eNodeB 504 and the second cell/frequency of the eNodeB 506.

To measure the signal quality of the eNodeB 506 when the UE 502 is being served by the eNodeB 504, the UE 502 may receive and measure a signal from the eNodeB 506, at time 514. When the signal quality of the eNodeB 504 fails to meet a first predefined signal quality threshold and the signal quality of the eNodeB 506 meets a second predefined signal quality threshold, cell reselection to the eNodeB 506 may be triggered by the eNodeB 504, at time 516.

While in the idle or connected mode, the UE 502 may be paged for a mobile-terminated (MT) voice call or may initiate a mobile-originated (MO) voice call, at time 518. As a result of the call, at time 520, the UE 502 may transmit an extended service request to the MME 510. The extended service request is part of the mobile-originated (MO) or mobile-terminated (MT) circuit switched fallback (CSFB) procedure.

The circuit switched fallback (CSFB) call (e.g., voice call) is initiated or received, at time 518, in concurrence with the triggering of the cell reselection, at time 516. However, delaying the circuit switched fall back procedure associated with the time sensitive voice call in favor of the cell reselection may increase the latency associated with setting up the voice call and degrade the user experience.

In one aspect of the disclosure, the UE 502 determines whether to abort the cell reselection procedure based a signal quality of the eNodeB 504 and/or a signal quality of eNodeB 506 and/or the NodeB 508, when the circuit switched fall back call is triggered during the ongoing cell reselection procedure. For example, when the signal quality of the eNodeB 504 exceeds an absolute threshold, at time 522, the UE 502 aborts the cell reselection procedure, at time 524. Alternatively, a completion percentage for the CSFB and/or cell reselection procedure may be considered. In place of the aborted cell reselection procedure, the UE 502 performs the circuit switched fall back procedure, at time 526 and connects to the NodeB 508 for the circuit switched fall back call. Although not shown, the UE 502 may subsequently perform cell reselection.

When the UE 502 determines, at time 522, that the signal quality of the eNodeB 504 falls below the absolute threshold, the UE 502 performs the cell reselection procedure, at time 528, and delays the circuit switched procedure until after the UE 502 reselects a new serving cell. For example, the UE 502 delays the circuit switched fall back procedure until the UE 502 reselects the eNodeB 506, at time 530. The UE 502 then performs the circuit switched fall back procedure, at time 532, and connects to the NodeB 508 for the circuit switched fall back call, at time 534.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

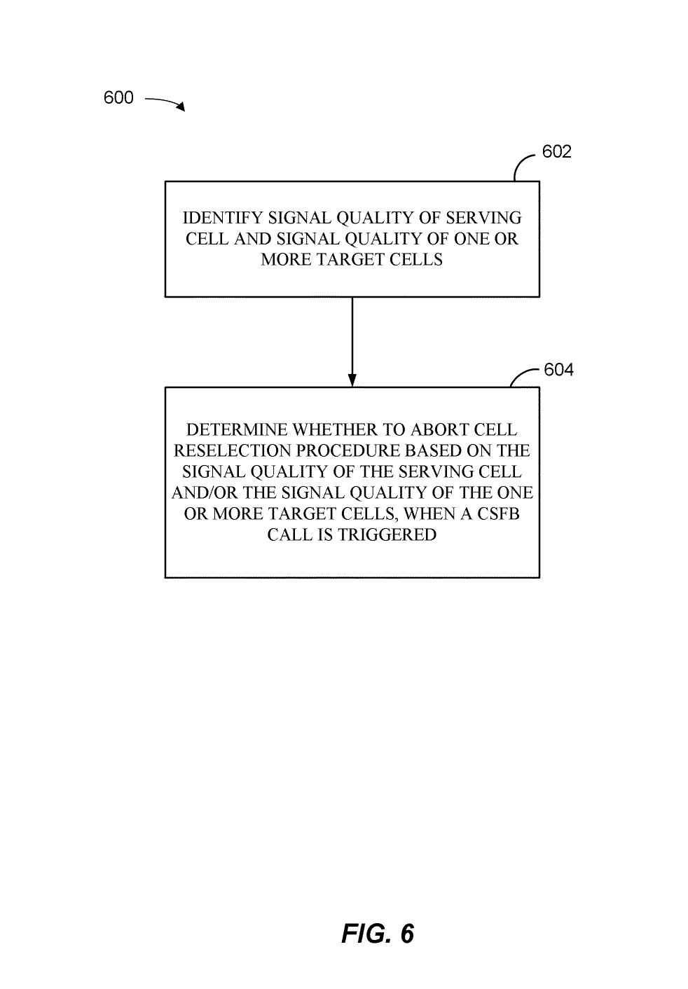

FIG. 6 shows a wireless communication method 600 according to one aspect of the disclosure. A UE identifies a signal quality of a serving cell and/or a signal quality of one or more cell reselection target cells, as shown in block 602. The signal quality may be determined by measurement of cells/frequencies of the serving cell and the one or more cell reselection target cells. The UE also determines whether to abort a cell reselection procedure based on a signal quality of the serving cell and/or the signal quality of the one or more cell reselection target cells, when a circuit switched fall back (CSFB) call has been triggered, as shown in block 604.

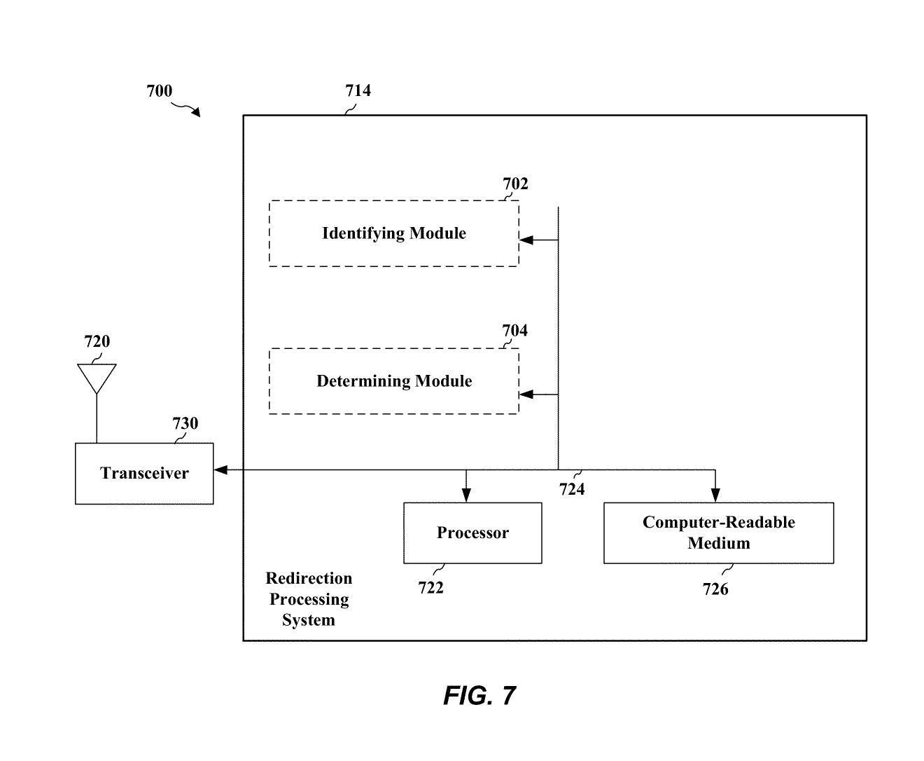

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatuses over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes an identifying module 702 for identifying a signal quality of a serving cell and/or a signal quality of one or more cell reselection target cells. The processing system 714 also includes a determining module 704 for determining whether to abort a cell reselection procedure based on a signal quality of the serving cell and/or the signal quality of the one or more cell reselection target cells, when a circuit switched fall back (CSFB) call has been triggered. The modules may be software modules running in the processor 722, resident/stored in the computer readable medium 726, one or more hardware modules coupled to the processor 722, or some combination thereof. The processing system 714 may be a component of the UE 350 and may include the memory 392, and/or the controller/processor 390.

In one configuration, an apparatus such as a UE, is configured for wireless communication including means for identifying. In one aspect, the identifying means may be the antennas 352/720, the receiver 354, the transceiver 730, the channel processor 394, the receive frame processor 360, the receive processor 370, the controller/processor 390, the memory 392, the redirection/reselection module 391, the identifying module 702, and/or the processing system 714 configured to perform the aforementioned means. The UE is also configured to include means for determining. In one aspect, the determining means may be the controller/processor 390, the memory 392, redirection/reselection module 391, the determining module 704 and/or the processing system 714 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system have been presented with reference to LTE, TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method for reducing latency of redirection during a concurrently triggered reselection, comprising:
determining when a circuit switched fall back (CSFB) call and a cell reselection procedure are concurrently triggered; and
determining whether to abort the cell reselection procedure based at least in part on a signal quality of a serving cell and/or a signal quality of at least one cell reselection target cell, when the CSFB call and the cell reselection procedure are concurrently triggered.

2. The method of claim 1, further comprising, when the serving cell signal quality exceeds an absolute threshold:
aborting the cell reselection procedure in response to the circuit switched fall back call being triggered when a cell reselection timer expired or when the cell reselection timer is running and is not expired; and
performing a circuit switched fall back procedure from the serving cell.

3. The method of claim 1, further comprising, when the serving cell signal quality is below an absolute threshold:
delaying a circuit switched fall back procedure until the cell reselection procedure is completed; and
resuming the circuit switched fall back procedure on a new serving cell.

4. The method of claim 1, further comprising determining whether to abort the cell reselection procedure or delay a circuit switched fall back procedure based at least in part on a signal quality difference between the serving cell and a cell reselection target cell.

5. The method of claim 1, further comprising determining whether to abort the cell reselection procedure or delay a circuit switched fall back procedure based at least in part on a percentage of the circuit switched fall back procedure completed.

6. The method of claim 1, further comprising determining whether to abort the cell reselection procedure or delay a circuit switched fall back procedure based at least in part on a percentage of the cell reselection procedure completed.

7. The method of claim 1, further comprising stopping intra frequency, inter frequency and/or inter radio access technology (RAT) measurements when the circuit switched fall back call has been triggered and the signal quality of the serving cell is above an absolute threshold.

8. The method of claim 1, in which the circuit switched fall back call is triggered in response to a mobile originated (MO) call.

9. The method of claim 1, in which the circuit switched fall back call is triggered in response to a mobile terminated (MT) call.

10. The method of claim 1, in which the cell reselection procedure comprises long term evolution (LTE) intra frequency cell reselection or inter frequency cell reselection.

11. An apparatus for wireless communication, comprising:
means for determining when a circuit switched fall back (CSFB) call and a cell reselection procedure are concurrently triggered;
means for identifying a signal quality of a serving cell and/or a signal quality of at least one cell reselection target cell; and
means for determining whether to abort the cell reselection procedure based at least in part on the signal quality of a serving cell and/or the signal quality of at least one cell reselection target cell, when the CSFB call and the cell reselection procedure are concurrently triggered.

12. The apparatus of claim 11, further comprising, when the serving cell signal quality exceeds an absolute threshold:
means for aborting the cell reselection procedure in response to the circuit switched fall back call being triggered when a cell reselection timer expired or when the cell reselection timer is running and is not expired; and
means for performing a circuit switched fall back procedure from the serving cell.

13. The apparatus of claim 11, further comprising, when the serving cell signal quality is below an absolute threshold:
means for delaying a circuit switched fall back procedure until the cell reselection procedure is completed; and
means for resuming the circuit switched fall back procedure on a new serving cell.

14. The apparatus of claim 11, further comprising means for determining whether to abort the cell reselection procedure or delay a circuit switched fall back procedure based at least in part on a signal quality difference between the serving cell and a cell reselection target cell.

15. The apparatus of claim 11, further comprising means for determining whether to abort the cell reselection procedure or delay a circuit switched fall back procedure based at least in part on a percentage of the circuit switched fall back procedure completed.

16. An apparatus for wireless communication, comprising:
a memory; and
at least one processor coupled to the memory and configured:
to determine when a circuit switched fall back (CSFB) call and a cell reselection procedure are concurrently triggered; and
to determine whether to abort the cell reselection procedure based at least in part on a signal quality of a serving cell and/or a signal quality of at least one cell reselection target cell, when the CSFB call and the cell reselection procedure are concurrently triggered.

17. The apparatus of claim 16, in which when the serving cell signal quality exceeds an absolute threshold, the at least one processor is further configured:
to abort the cell reselection procedure in response to the circuit switched fall back call being triggered when a cell reselection timer expired or when the cell reselection timer is running and is not expired; and
to perform a circuit switched fall back procedure from the serving cell.

18. The apparatus of claim 16, in which when the serving cell signal quality is below an absolute threshold, the at least one processor is further configured:
to delay a circuit switched fall back procedure until the cell reselection procedure is completed; and
to resume the circuit switched fall back procedure on a new serving cell.

19. The apparatus of claim 16, in which the at least one processor is further configured to determine whether to abort the cell reselection procedure or delay a circuit switched fall back procedure based at least in part on a signal quality difference between the serving cell and a cell reselection target cell.

20. The apparatus of claim 16, in which the at least one processor is further configured to determine whether to abort the cell reselection procedure or delay a circuit switched fall back procedure based at least in part on a percentage of the circuit switched fall back procedure completed.

21. The apparatus of claim 16, in which the at least one processor is further configured to determine whether to abort the cell reselection procedure or delay a circuit switched fall back procedure based at least in part on a percentage of the cell reselection procedure completed.

22. The apparatus of claim 16, in which the at least one processor is further configured to stop intra frequency, inter frequency and/or inter radio access technology (RAT) measurements when the circuit switched fall back call has been triggered and the signal quality of the serving cell is above an absolute threshold.

23. The apparatus of claim 16, in which the circuit switched fall back call is triggered in response to a mobile originated (MO) call.

24. The apparatus of claim 16, in which the circuit switched fall back is triggered in response to a mobile terminated (MT) call.

25. The apparatus of claim 16, in which the cell reselection procedure comprises long term evolution (LTE) intra frequency cell reselection or inter frequency cell reselection.

26. A non-transitory computer-readable medium having program code recorded thereon for reducing latency of redirection during a concurrently triggered reselection, the program code comprising:
program code to determine when a circuit switched fall back (CSFB) call and a cell reselection procedure are concurrently triggered; and
program code to determine whether to abort the cell reselection procedure based at least in part on a signal quality of a serving cell and/or a signal quality of at least one cell reselection target cell, when the CSFB call and the cell reselection procedure are concurrently triggered.

27. The computer program product of claim 26, further comprising, when the serving cell signal quality exceeds an absolute threshold:
program code to abort the cell reselection procedure in response to the circuit switched fall back call being triggered when a cell reselection timer expired or when the cell reselection timer is running and is not expired; and
program code to perform a circuit switched fall back procedure from the serving cell.

28. The computer program product of claim 26, further comprising, when the serving cell signal quality is below an absolute threshold:
program code to delay a circuit switched fall back procedure until the cell reselection procedure is completed; and
program code to resume the circuit switched fall back procedure on a new serving cell.

29. The computer program product of claim 26, further comprising program code to determine whether to abort the cell reselection procedure or delay a circuit switched fall back procedure based at least in part on a signal quality difference between the serving cell and a cell reselection target cell.

30. The computer program product of claim 26, further comprising program code to determine whether to abort the cell reselection procedure or delay a circuit switched fall back procedure based at least in part on a percentage of the circuit switched fall back procedure completed.
